(19) United States
(12) Patent Application Publication
(10) Pub. No.: US 2007/0214160 A1
(43) Pub. Date: Sep. 13, 2007

(54) System and method for characterizing and generating data resembling a real population

(76) Inventor: David Imran Noor, Las Vegas, NV (US)

Correspondence Address: IBM CORPORATION - SVL (JVL);C/O VANLEEUWEN & VANLEEUWEN, P.O. BOX 90609, AUSTIN, TX, 78709-0609, US

(21) Appl. No.: 11/369,619

(22) Filed: Mar. 7, 2006

(51) Int. Cl. G06F 7/00

(52) U.S. Cl. 707/101

(57) ABSTRACT

A system, method, and program product are provided that generates population data by receiving a desired human population description from a user. The system, method, and program product then randomly generates attributes corresponding to a number of generated individuals, based on the received population description. The system, method, and program product relate some individuals to some of the generated individuals. In order to relate the related individuals to the generated individuals, the system, method, and program product select attributes corresponding to one of the generated individuals, include some of the selected attributes as attributes of the related individual, and retrieve additional attributes for the related individual, the additional attributes being different than the selected attributes. Finally, the system, method, and program product store the attributes corresponding to the generated and related individuals in a data store.

### BACKGROUND OF THE INVENTION

1. Technical Field

The present invention relates in general to a system and method for generating test data. More particularly, the present invention relates to a system and method that creates test data resembling real population.

2. Description of the Related Art

In many development and research projects, it is often useful to test using data that resembles a real world population. Real world population data is needed in order to ensure that the system or project being developed operates as expected when handling real world population data.

One approach is to extract real world population data from real world sources such as telephone books. A challenge of this approach, however, is that using real data can be dangerous as it can lead to identity theft and other violations of individuals' personal privacy.

Another approach is to generate test data for individuals. However, using traditional tools, this generated test data lacks the ability to capture relationship information between individuals (such as family members in a common household), nor do traditional test data address the propensity for individuals to occasionally “mutate” their identities (such as using aliases or nicknames).

What is needed, therefore, is a system and method that generates test data that more resembles a real world population while still maintaining individuals' privacy. What is further needed is a system and method that simulates relationships between individuals as well as addressing individuals' propensities to “mutate” their identities.

### SUMMARY

It has been discovered that the aforementioned challenges are resolved using a system, method, and program product that generates population data by receiving a desired human population description from a user. The system, method, and program product then randomly generates attributes corresponding to a number of generated individuals, based on the received population description. The system, method, and program product relate some individuals to some of the generated individuals. In order to relate the related individuals to the generated individuals, the system, method, and program product select attributes corresponding to one of the generated individuals, include some of the selected attributes as attributes of the related individual, and retrieve additional attributes for the related individual, the additional attributes being different than the selected attributes. Finally, the system, method, and program product store the attributes corresponding to the generated and related individuals in a data store.

In one embodiment, the system, method, and program product generate the individuals by randomly selecting attribute data from one or more input data sources. In this embodiment, the system, method, and program product match attributes from the randomly selected attribute data to stored attribute data corresponding to individuals that were previously generated. In this embodiment, the system, method, and program product repeatedly select attributes until the selected attributes are not found in the previously generated data. The system, method, and program product then stores the randomly selected attribute data in the stored attribute data. In an alternative embodiment, the randomly selected attributes are retrieved by one or more data stores. In another alternative embodiment, the attributes include any number of a last name, a first name, a middle name, a street address, a city, a state, a province, a geographic region, a country, a postal code, a telephone number, an email address, an age, a marital status, an income, a social security number, and an identification number.

In one embodiment, the system, method, and program product convert the attributes to a markup language format (e.g., XML) prior to storing them

In one embodiment, the number of related individuals is based upon the population description received from the user.

In one embodiment, some of the related individuals are aliases of the generated individuals and some of the related individuals have familial relationships with the generated individuals.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a high level flowchart showing the creation of population files based upon desired population characteristics;

FIG. 2 is a flowchart showing the steps taken during data generation;

FIG. 3 is a flowchart showing the steps taken to generate the desired output files of semi-random population data;

FIG. 4 is a flowchart showing the steps taken to generate the records stored in the output files;

FIG. 5 is a flowchart showing the steps taken to randomly create new identifying attributes used when generating the records stored in the output files; and

FIG. 6 is a block diagram of a broadband engine that includes a plurality of heterogeneous processors in which the present invention can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

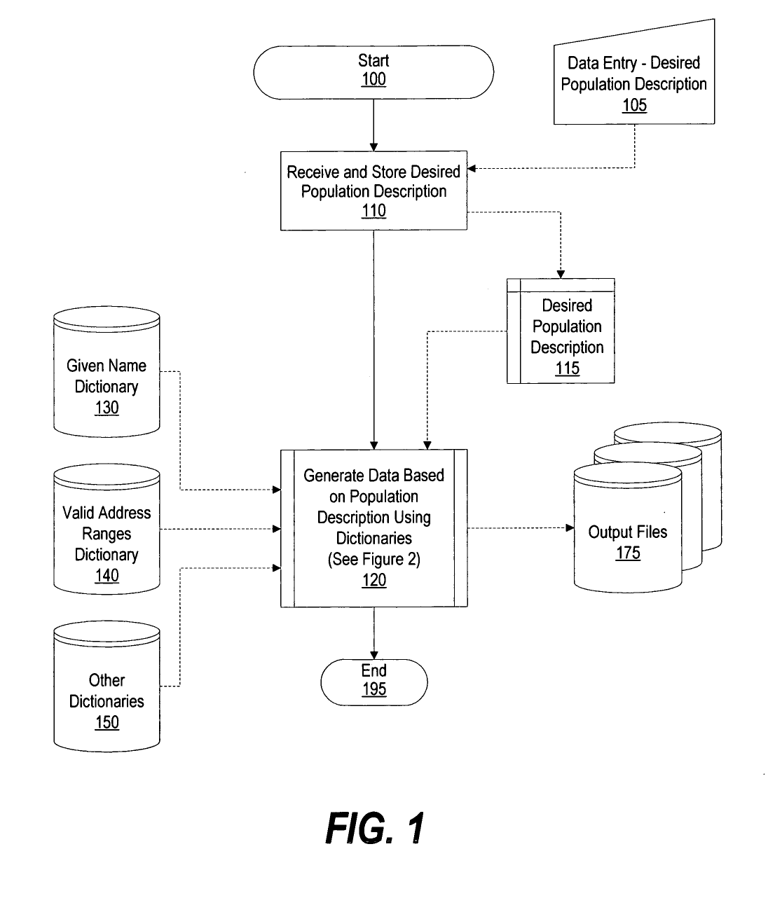

FIG. 1 is a high level flowchart showing the creation of population files based upon desired population characteristics. High level processing commences at 100 whereupon, at step 110, a description of the desired human population is received from the user using manual input 105. The received desired human population description is stored in memory 115.

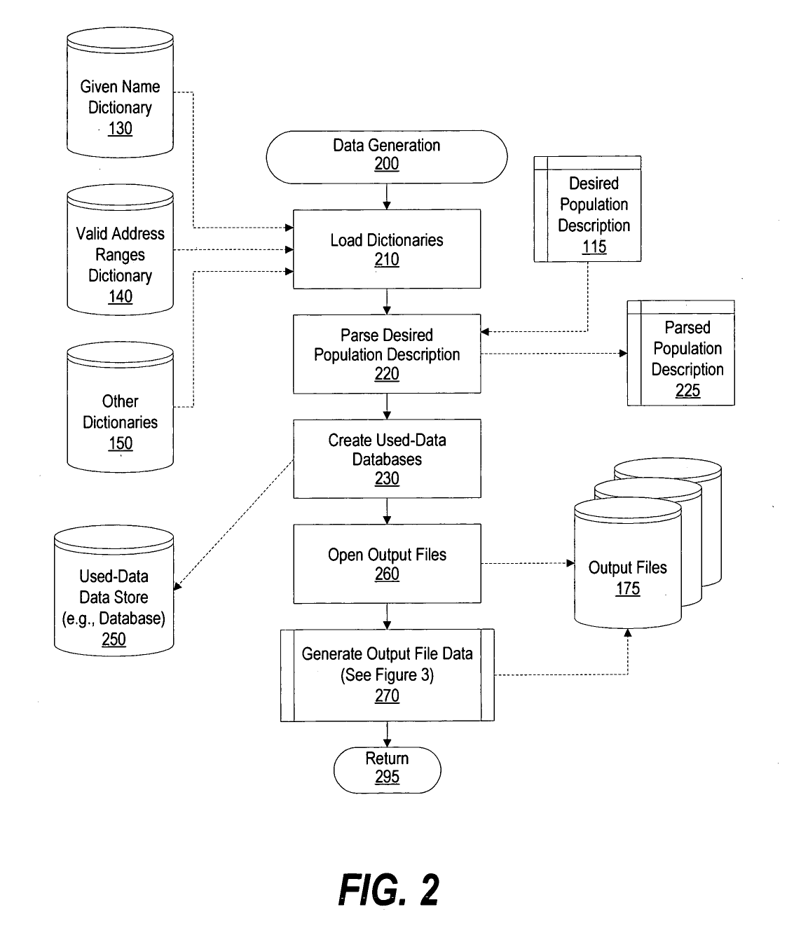

Random population data is then generated based upon the received desired human population description (predefined process 120, see FIG. 2 and corresponding text for processing details). Predefined process 120 retrieves data from one or more input data stores, such as name dictionary 130, address dictionary 140, and other dictionaries 150. Predefined process 120 stores the data in one or more output data stores 175. After predefined process 120 finishes creating output data stores 175, processing ends at 195.

Name dictionary data store 130 includes attributes such as last names, first names, and middle names. Address dictionary data store 140 includes street addresses, city names, state names, province names, geographic region names, country names, and postal codes. Attributes such as telephone numbers, email addresses, ages of individuals, and marital status can be included in any one of the data stores (130-150). Additional demographic information, such as income attributes, can also be included in any one of the input data stores. Finally, unique identification attributes, such as social security numbers and other identification numbers can be included in one or more of the input data stores.

FIG. 2 is a flowchart showing the steps taken during data generation. Processing commences at 200 whereupon, at step 210, the dictionaries (input data stores) that will be used to create the population data are loaded. Input files can be standard disk files or database tables, such as those managed by a database management system (DBMS). At step 220, the desired population description that was provided by the user and stored in memory 115 is parsed and stored in memory 225.

The parsed population description indicates the number of individuals to generate as well as the percentage, or number, of related individuals to generate. For example, if a population of one million records (generated individuals) are generated, the user might decide that twenty percent of the records are related (related individuals). In this case, two hundred thousand records would be related. Related individuals can be directly related to a generated individual, such as an alias for a given individual. For example, the generated individual could have a name of “Jonathon Doe” and a related individual (an alias) of “John Doe.” The generated and related individual could also share additional attributes, other than last name, such as address information or other demographic attribute data. Another relationship between generated individuals and related individuals are familial relationships. For example, a household of individuals could have generated individual (e.g., a mother), and one or more related individuals such as children and a spouse. In a nuclear familial relationship, a last name is often a shared attribute as well as address information for some or all of the individuals.

At step 230, one or more used data stores 250 are created (such as files or databases). As the name implies, the used data stores store attribute data for individuals that have already been generated (either with or without relationships). When generating a new individual, this used data is searched to determine whether the attributes that identify the new individual have already been used. The level of granularity for determining whether attributes have already been used can be customized. For example, if a “John Doe” has already been generated and stored in used data store 250 then another individual might not be able to be generated with the same name (John Doe). Recognizing that some attributes, such as common names, often appear in a real population, the generating can be programmed to allow some level of matching attributes before re-selecting attributes for the new individual. For example, duplicate name attributes (e.g., “John Smith”) can be allowed so long as they have different address attributes, while other attribute data, such as a social security number or other unique identifying number, many not be duplicated (unless, of course, duplication of such identification information is useful for the simulation processing the resulting output data, such as a simulation or algorithm designed to identify identity theft).

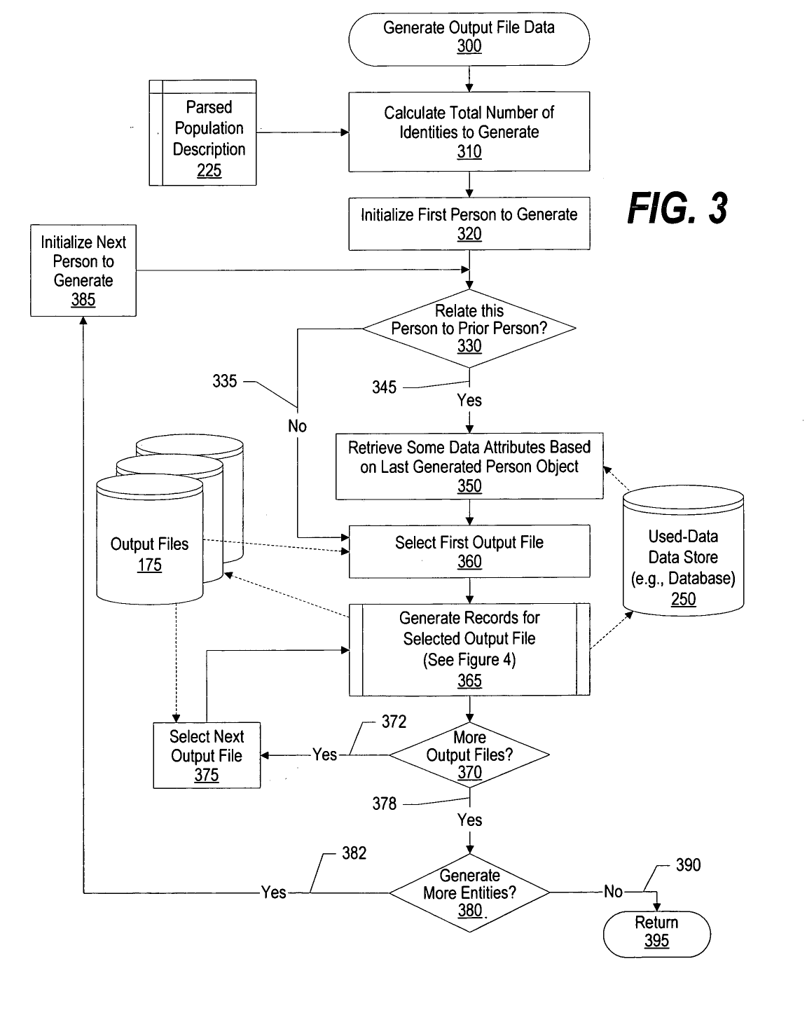

At step 260, one or more output files 175 is opened. Output files can be standard disk files or database tables, such as those managed by a database management system (DBMS). The data stored in output data stores 175 is generated using predefined process 270 (see FIG. 3 and corresponding text for processing details). After the data has been generated and stored in the output data stores, processing returns to the calling routine (see FIG. 1) at 295.

FIG. 3 is a flowchart showing the steps taken to generate the desired output files of semi-random population data. Processing commences at 300 whereupon, at step 310, the total number of entities (individuals) to generate is calculated based upon the parsed population description stored in memory 225. At step 320, the first person (individual) that will be generated is initialized.

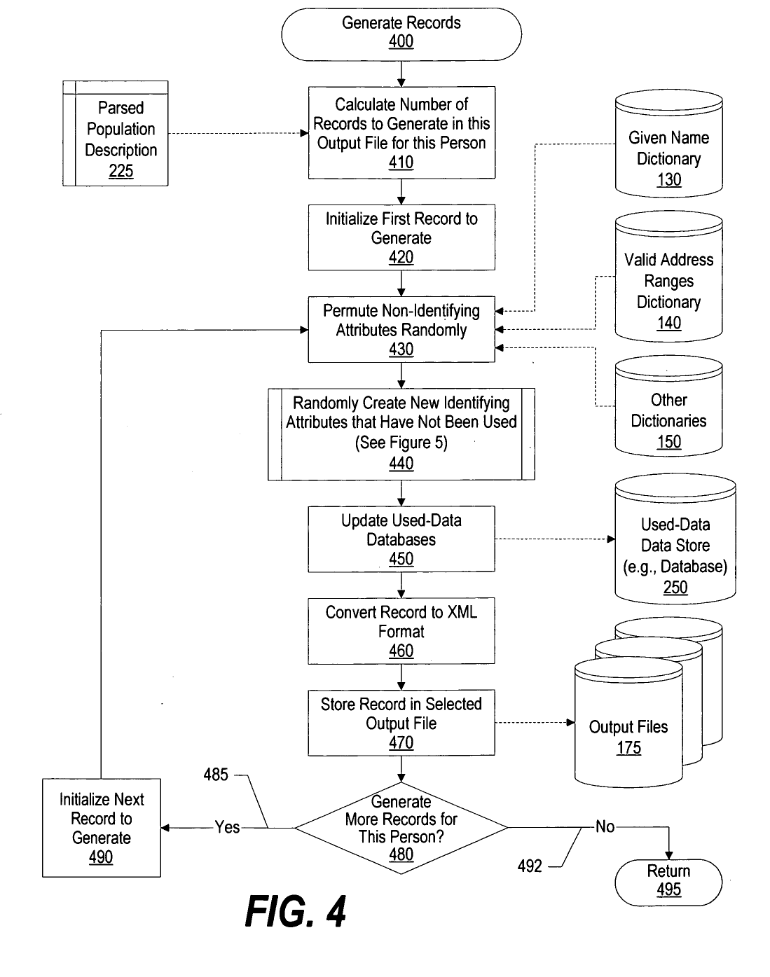

A determination is made as to whether to relate the initialized individual to another individual (decision 330). This determination is based upon the parsed population description that indicated the number (i.e., a percentage) of individuals that should be related. For example, if twenty percent of the individuals are related, then decision 330 would be true (branch to “yes” branch 345) about twenty percent of the time would be false (branch to “no” branch 335) about eighty percent of the time. Of course, for the first individual, there are no previous individuals that can be related, so decision 330 branches to “no” branch 335 whereupon, at step 360, the first (or only) output data store 175, such as a file or database table, is selected. At predefined process 365, records are generated for the selected output file (see FIG. 4 and corresponding text for processing details). A record of the generated data is stored in used data store 250. A determination is made as to whether data needs to be generated for more output data stores (decision 370). If data is being generated for additional output data stores, then decision 370 branches to “yes” branch 372 whereupon, at step 375, the next output data store is selected and processing loops back to generate records for the newly selected data store. This looping continues until data has been generated for all output data stores, at which point decision 370 branches to “yes” branch 378.

A determination is made as to whether more entities (individuals) should be generated (decision 380). Since only one individual has been generated at this point, decision 380 branches to “yes” branch 382 whereupon, at step 385, the next individual to be generated is initialized and processing loops back to generate the data for the newly initialized individual. At decision 330, if (based on the parsed population description), it is determined that the newly initialized individual should be related to a previously generated individual, decision 330 branches to “yes” branch 345 whereupon, at step 350, some data attributes are retrieved from a previously generated individual whose attributes were stored in used data store 250. Related individuals can be directly related to a generated individual, such as an alias for a given individual. Individuals can be related in a number of ways. For example, the generated individual could have a name of “Jonathon Doe” and a related individual (an alias) of “John Doe.” The generated and related individual could also share additional attributes, other than last name, such as address information or other demographic attribute data. Another relationship between generated individuals and related individuals are familial relationships. For example, a household of individuals could have generated individual (e.g., a mother), and one or more related individuals such as children and a spouse. In a nuclear familial relationship, a last name is often a shared attribute as well as address information for some or all of the individuals. Processing continues to select output files and generate records for the related individual (step 360 through 375).

Returning to decision 380, decision 380 continues to branch to “yes” branch 380 until enough individuals to satisfy the desired population (determined by the parsed population description stored in memory 225) have been generated. When the number of individuals needed for the desired population have been generated, decision 380 branches to “no” branch 390 and processing returns to the calling routine (see FIG. 2) at 395.

FIG. 4 is a flowchart showing the steps taken to generate the records stored in the output files. Processing commences at 400 whereupon, at step 410, the number of records (i.e., entries) to generate for this individual are calculated based upon the user's desired population description stored in memory 225. At step 420, the first record for the selected output data store (i.e., file, data base table, etc.) is initialized. At step 430, the system randomly gathers non-identifying attributes from various input data stores, such as name dictionary 130, address dictionary 140, and other dictionaries 150. Non-identifying attributes would be those attributes that would not uniquely identify an individual. For example, a social security number would not be a non-identifying attribute, but an income level would be a non-identifying attribute. Moreover, a particular street address would not be a non-identifying attribute, but attributes such as a city, state, and zip code would be non-identifying attributes.

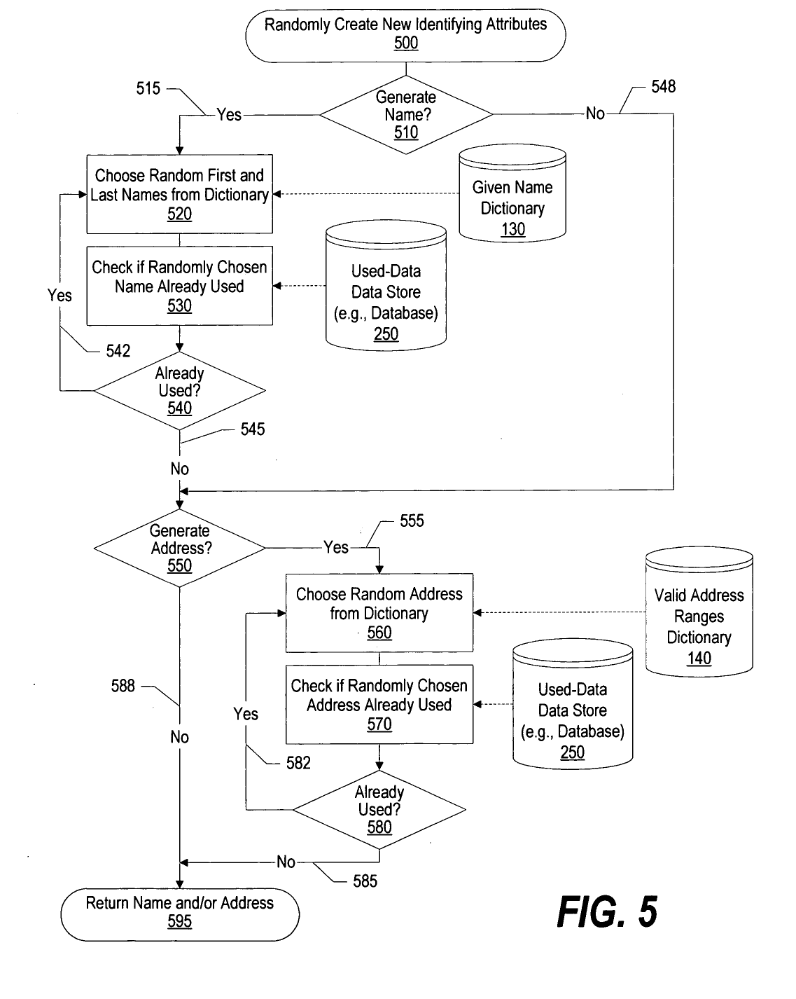

At predefined process 440, the system randomly creates new identifying attributes that have not yet been used by another generated individual (see FIG. 5 and corresponding text for processing details). After the non-identifying and identifying attributes have been generated, at step 450, used-data data store 250 is updated with the generated data. In one embodiment, only the identifying attribute data is stored in used-data data store 250 because this is the only information that will be checked for redundancy.

In one embodiment, the record is converted to a markup language format, such as the Extended Markup Language (XML) format. This conversion is performed at step 460. Markup language formats are useful for output data stores because of the power and flexibility this format offers to programs that will be assigned to read and process the sample population data stored in output files 175. At step 470 the record (regardless of whether it was converted to XML) is stored in the selected output file (output data stores 175). After the record has been stored, a determination is made as to whether, based on the user's population description, additional records should be generated for this output file. If additional records need to be generated, decision 480 branches to “yes” branch 485 whereupon, at step 490, the next record is initialized and processing loops back to generate and store the newly initialized record. This looping continues until no more records are needed, at which point decision 480 branches to “no” branch 492 and processing returns to the calling routine (see FIG. 3) at 495.

FIG. 5 is a flowchart showing the steps taken to randomly create new identifying attributes used when generating the records stored in the output files. While the steps shown in FIG. 5 only generate names and street addresses, it will be appreciated by those skilled in the art that these techniques can be used to generate additional identifying attributes, such as unique identification numbers (e.g., social security numbers).

Processing commences at 500 whereupon, a determination is made as to whether one of the identifying attributes to be generated is the generated individual's name (decision 510). If a name is being generated, decision 510 branches to “yes” branch 515 whereupon, at step 520, a first and last (and perhaps a middle) name are randomly chosen from an input data store, in this case, name dictionary 130. In one embodiment, one entry from name dictionary is used for the first name and a second entry is used for the last name. In this manner, if real data is stored in name dictionary 130, it is more unlikely that the generated name will match a particular record in the dictionary.

At step 530, a check is made to see whether the randomly chosen name chosen in step 520 has already been used for another generated individual. This check is made by comparing the generated name to the names stored in used-data data store 250. A determination is made as to whether the chosen name has already been used (decision 540). If the name has already been used, decision 540 branches to “yes” branch 542 to randomly choose a different first and last name. This looping continues until a name has been generated that has not already been used, at which point decision 540 branches to “no” branch 545.

When a unique name has been generated (decision 540 branching to “no” branch 545) or if a name is not being generated (decision 510 branching to “no” branch 548), then a determination is made as to whether an address is being generated (decision 555). If an address is being generated, decision 550 branches to “yes” branch 555 whereupon, at step 560, a random address is chosen from address dictionary 140. In one embodiment, the address dictionary contains street addresses, while in another embodiment, the address dictionary contains street addresses along with the city, state (or province), postal code, country, and any other data used to form an address. At step 570, a check is made to see whether the randomly chosen address is already being used by another generated individual by comparing the generated address to attribute data stored in used-data data store 250. A determination is made as to whether the address is already being used by another generated individual (decision 580). If the address is already being used, decision 580 branches to “yes” branch 582 which loops back to choose a different address. This looping continues until an address not used by another generated individual has been chosen, at which point decision 580 branches to “no” branch 585.

If either an address is not being generated (decision 550 branching to “no” branch 588) or when the address is chosen (decision 580 branching to “no” branch 585, then processing returns the generated name and/or address to the calling routine (see FIG. 4) at 595.

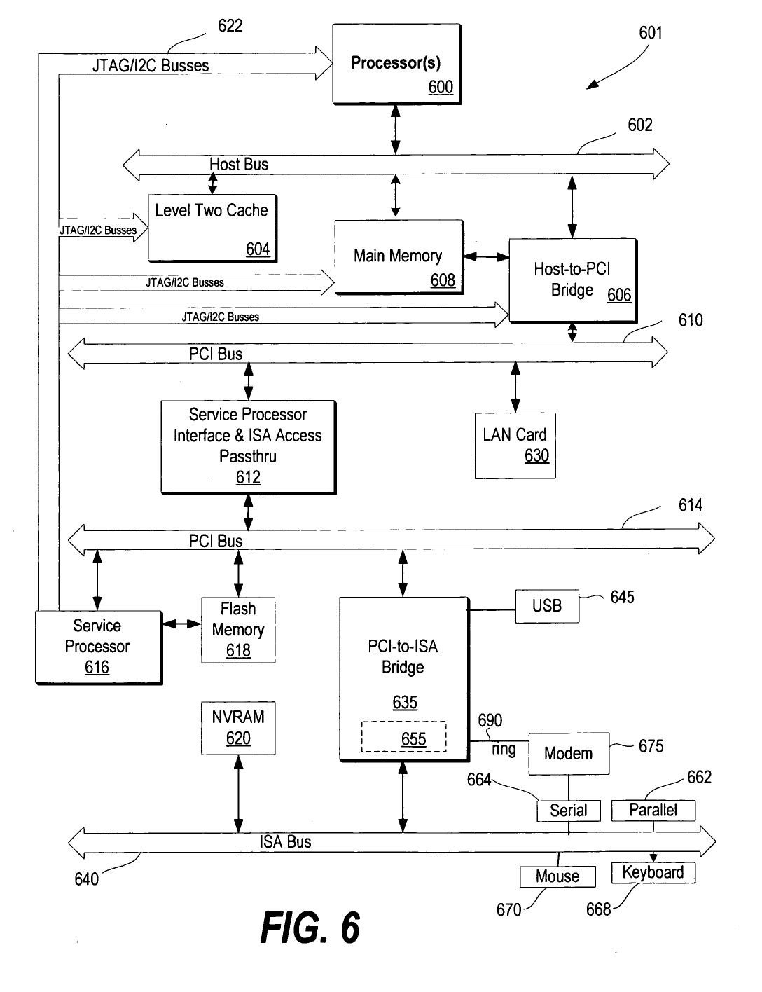

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving a desired human population description;
randomly generating attributes corresponding to a plurality of generated individuals, the generating based on the received population description;
relating a plurality of related individuals to one or more of the generated individuals, wherein, for each of the related individuals, the relating further includes:
selecting attributes corresponding to one of the generated individuals;
including one or more of the selected attributes as attributes of the related individual; and
retrieving additional attributes corresponding to the related individual, wherein the additional attributes are different than the selected attributes; and
storing the attributes corresponding to the generated and related individuals in a data store.

2. The method of claim 1 wherein the generating further comprises:
randomly selecting attribute data from one or more input data sources;
matching one or more attributes from the randomly selected attribute data to stored attribute data corresponding to previously generated individuals;
in response to the attributes matching the stored attribute data, repeating the randomly selecting for the matched attributes and the matching until the attributes do not match the stored attribute data; and
storing the randomly selected attribute data in the stored attribute data when the attributes do not match the stored attribute data.

3. The method of claim 2 wherein the randomly selecting further comprises:
retrieving attribute data from one or more input data stores.

4. The method of claim 2 wherein one or more of the attributes are selected from the group consisting of a last name, a first name, a middle name, a street address, a city, a state, a province, a geographic region, a country, a postal code, a telephone number, an email address, an age, a marital status, an income, a social security number, and an identification number.

5. The method of claim 1 further comprising:
converting the attributes corresponding to the generated and related individuals to a markup language format prior to storing the attributes.

6. The method of claim 1 wherein the number of the plurality of related individuals is based upon the received population description.

7. The method of claim 1 wherein a plurality of the related individuals are aliases of the selected generated individuals and wherein a plurality of the related individuals have familial relationships with the selected generated individuals.

8. A information handling system comprising:
at least one processor;
at least one memory associated with the at least one processor;
a nonvolatile storage area associated with the at least one processor; and
a set of instructions contained within the at least one memory, wherein the at least one processor executes the set of instructions in order to perform actions of:
receiving a desired human population description;
randomly generating attributes corresponding to a plurality of generated individuals, the generating based on the received population description;
relating a plurality of related individuals to one or more of the generated individuals,
wherein, for each of the related individuals, the relating further includes:
selecting attributes corresponding to one of the generated individuals;
including one or more of the selected attributes as attributes of the related individual; and
retrieving additional attributes corresponding to the related individual,
wherein the additional attributes are different than the selected attributes; and
storing the attributes corresponding to the generated and related individuals in a data store.

9. The information handling system of claim 8 wherein the set of instructions used for generating further performs actions of:
randomly selecting attribute data from one or more input data sources;
matching one or more attributes from the randomly selected attribute data to stored attribute data corresponding to previously generated individuals;
in response to the attributes matching the stored attribute data, repeating the randomly selecting for the matched attributes and the matching until the attributes do not match the stored attribute data; and
storing the randomly selected attribute data in the stored attribute data when the attributes do not match the stored attribute data.

10. The information handling system of claim 9 wherein the set of instructions used for randomly selecting further performs actions of:
retrieving attribute data from one or more input data stores.

11. The information handling system of claim 8 wherein the set of instructions further performs actions of:
converting the attributes corresponding to the generated and related individuals to a markup language format prior to storing the attributes.

12. The information handling system of claim 8 wherein the number of the plurality of related individuals is based upon the received population description.

13. The information handling system of claim 8 wherein a plurality of the related individuals are aliases of the selected generated individuals and wherein a plurality of the related individuals have familial relationships with the selected generated individuals.

14. A computer program product in a computer readable medium, comprising functional descriptive material that, when executed by a data processing system, causes the data processing system to perform actions that include:
receiving a desired human population description;
randomly generating attributes corresponding to a plurality of generated individuals, the generating based on the received population description;
relating a plurality of related individuals to one or more of the generated individuals, wherein, for each of the related individuals, the relating further includes:
selecting attributes corresponding to one of the generated individuals;
including one or more of the selected attributes as attributes of the related individual; and
retrieving additional attributes corresponding to the related individual, wherein the additional attributes are different than the selected attributes; and
storing the attributes corresponding to the generated and related individuals in a data store.

15. The computer program product of claim 14 further comprising functional descriptive material that, when executed by a data processing system, causes the data processing system to perform actions that include:
randomly selecting attribute data from one or more input data sources;
matching one or more attributes from the randomly selected attribute data to stored attribute data corresponding to previously generated individuals;
in response to the attributes matching the stored attribute data, repeating the randomly selecting for the matched attributes and the matching until the attributes do not match the stored attribute data; and
storing the randomly selected attribute data in the stored attribute data when the attributes do not match the stored attribute data.

16. The computer program product of claim 15 wherein the functional descriptive material used to perform the randomly selecting further includes functional descriptive material that, when executed by a data processing system, causes the data processing system to perform actions that include:
retrieving attribute data from one or more input data stores.

17. The computer program product of claim 15 wherein one or more of the attributes are selected from the group consisting of a last name, a first name, a middle name, a street address, a city, a state, a province, a geographic region, a country, a postal code, a telephone number, an email address, an age, a marital status, an income, a social security number, and an identification number.

18. The computer program product of claim 14 further comprising functional descriptive material that, when executed by a data processing system, causes the data processing system to perform actions that include:
converting the attributes corresponding to the generated and related individuals to a markup language format prior to storing the attributes.

19. The computer program product of claim 14 wherein the number of the plurality of related individuals is based upon the received population description.

20. The computer program product of claim 14 wherein a plurality of the related individuals are aliases of the selected generated individuals and wherein a plurality of the related individuals have familial relationships with the selected generated individuals.
